(19) United States
(12) Patent Application Publication
(10) Pub. No.: US 2025/0282996 A1
(43) Pub. Date: Sep. 11, 2025

(54) ALIGNMENT FILM COMPOSITION, DISPLAY PANEL AND METHOD OF MANUFACTURE THEREOF

(71) Applicant: TCL CHINA STAR OPTOELECTRONICS TECHNOLOGY CO., LTD., Shenzhen (CN)

(72) Inventors: Shuang LU, Shenzhen (CN); Ji LI, Shenzhen (CN)

(73) Assignee: TCL CHINA STAR OPTOELECTRONICS TECHNOLOGY CO., LTD., Shenzhen (CN)

(21) Appl. No.: 18/822,172

(22) Filed: Aug. 31, 2024

(30) Foreign Application Priority Data
Mar. 7, 2024 (CN) 202410266961.0

(51) Int. Cl. C09K 19/56; C08K 5/134; G02F 1/1337

(52) U.S. Cl. CPC C09K 19/56; C08K 5/134; C08K 5/1345; G02F 1/1337

(57) ABSTRACT

The present disclosure provides an alignment film composition, a display panel, and a manufacturing method thereof. The display panel includes a first substrate; a second substrate disposed opposite to the first substrate; a first alignment film disposed on a side of the first substrate close to the second substrate; and a second alignment film disposed on a side of the second substrate close to the first substrate; wherein each of the first alignment film and the second alignment film includes at least one of the following functional groups:

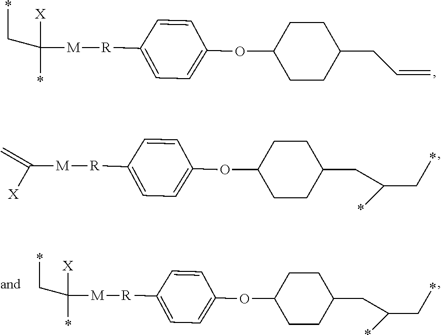

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

### CROSS-REFERENCE TO RELATED APPLICATION

The present disclosure claims priority to and the benefit of Chinese Patent Application No. 202410266961.0, filed on Mar. 7, 2024, the disclosure of which is incorporated herein by reference in its entirety.

### TECHNICAL FIELD

The present disclosure relates to the field of display, and more particularly, to an alignment film composition, a display panel, and a method for manufacturing a display panel.

### BACKGROUND

With the continuous development of liquid crystal panel manufacturing technology, the current liquid crystal filling technology has basically developed from a conventional crystal filling technology to an one drop filling (ODF) technology. In ODF technology, liquid crystals are dropped on one substrate through a liquid crystal dripping device, and then assembled with another substrate, in this way, time of a manufacturing process is reduced and materials are saved. However, in the manner that liquid crystals are dropped instead of being absorbed, uneven distribution of the liquid crystals is easy to occur, resulting in the phenomenon of drop mura, which in turn affects the display effect.

### SUMMARY

The embodiments of the present disclosure provide an alignment film composition, a display panel, and a manufacturing method thereof, which can improve the distribution uniformity of liquid crystal molecules in the display panel.

Some embodiment of the present disclosure provides a display panel, which includes:
a first substrate;
a second substrate disposed opposite to the first substrate;
a first alignment film disposed on a side of the first substrate close to the second substrate; and
a second alignment film disposed on a side of the second substrate close to the first substrate;
wherein each of the first alignment film and the second alignment film includes at least one of the following functional groups:

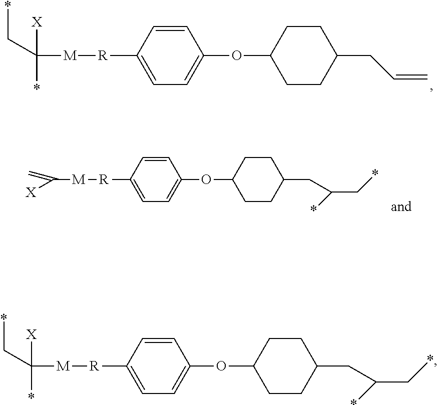

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

In some embodiments of the present disclosure, the M includes at least one of a phenyl group and a cyclohexyl group.

In some embodiments of the present disclosure, the R includes at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms; and
wherein the M includes one of

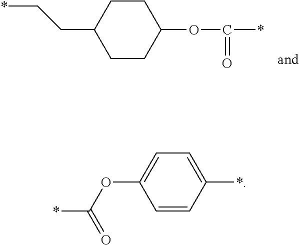

In some embodiments of the present disclosure, each of the first alignment film and the second alignment film includes at least one of the following functional groups:

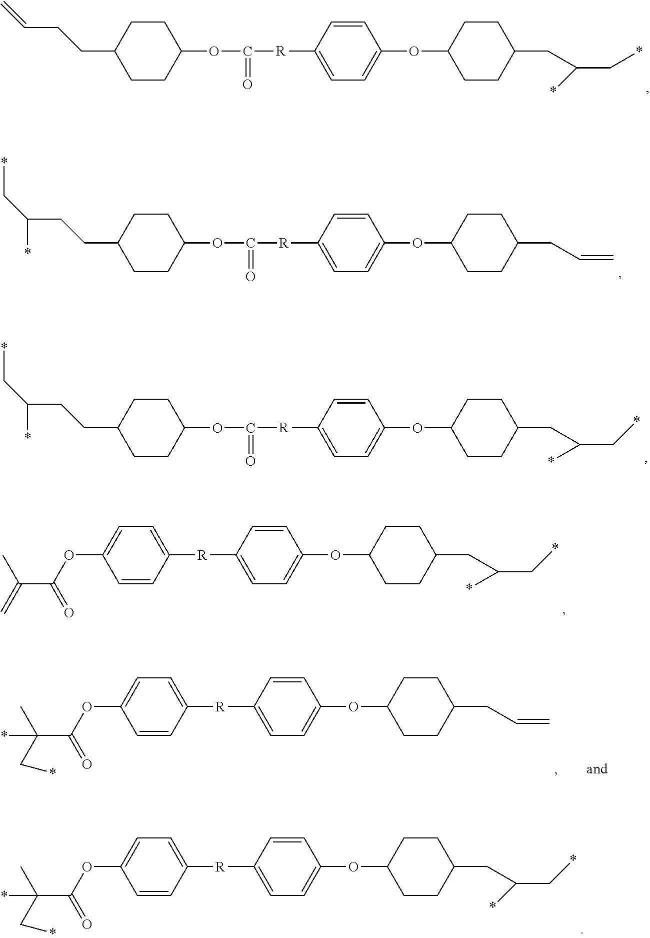

In some embodiments of the present disclosure, each of the first alignment film and the second alignment film includes at least one of the following functional groups:

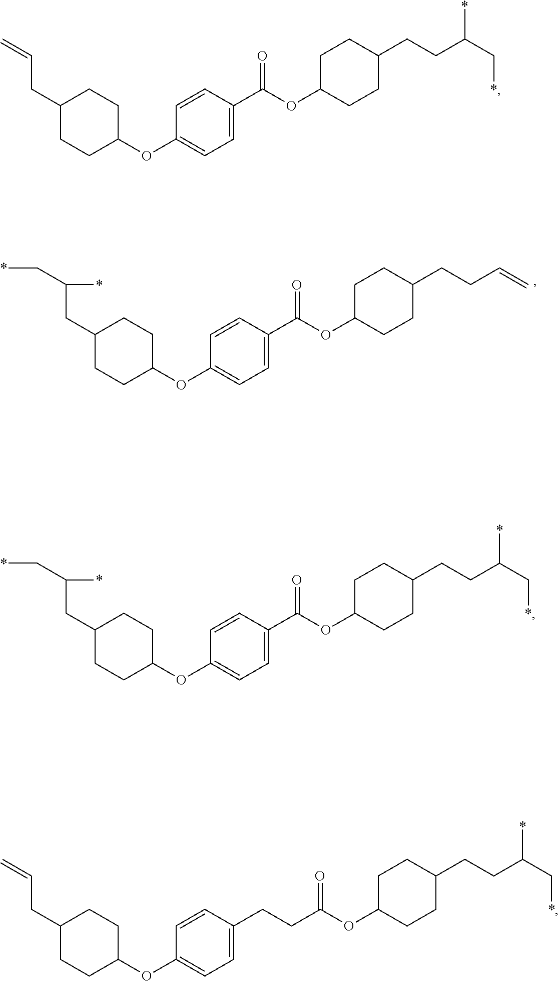

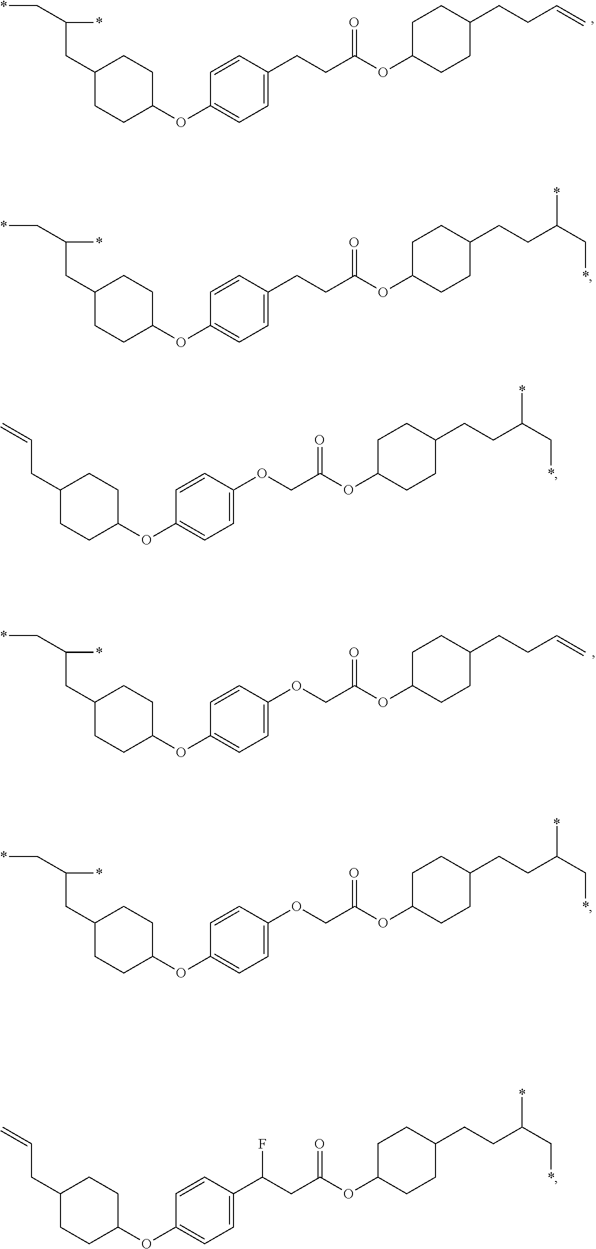

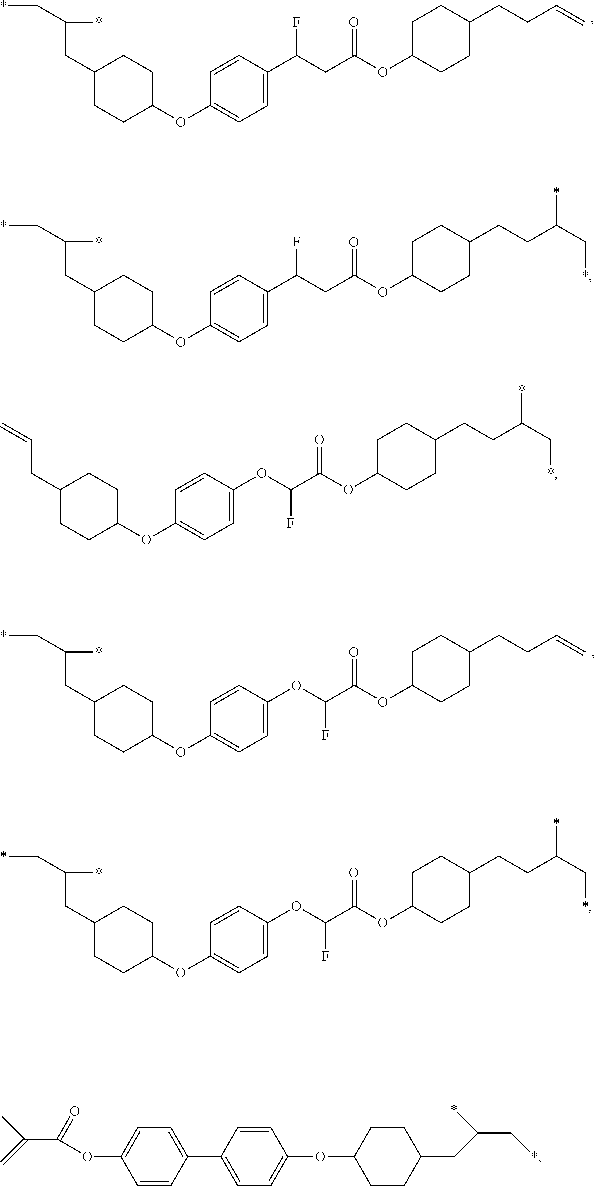

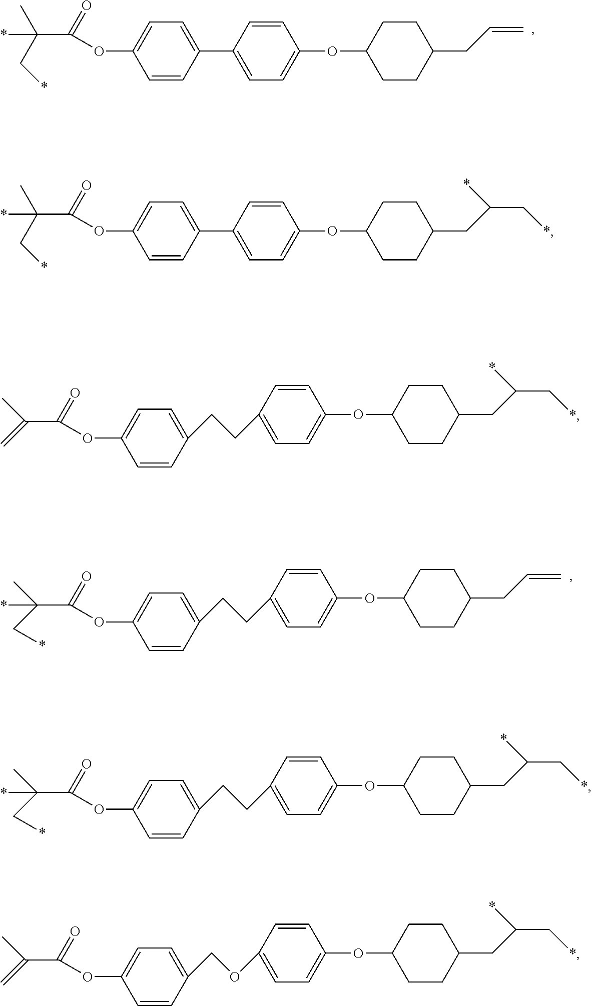

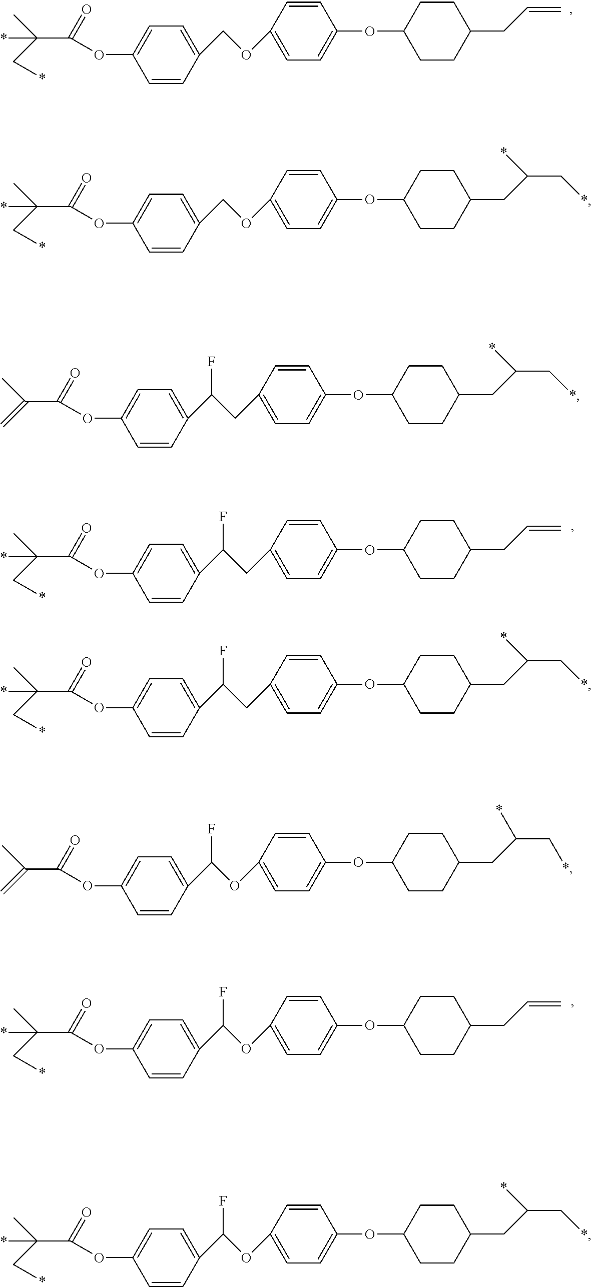

In some embodiments of the present disclosure, the display panel further includes a liquid crystal layer disposed between the first alignment film and the second alignment film. The liquid crystal layer further liquid crystal molecules, and the liquid crystal molecules include at least one six-membered ring.

In some embodiments of the present disclosure, the liquid crystal layer further includes a polymer network structure connected to the first alignment film and/or the second alignment film.

According to the above object of the present disclosure, some embodiments of the present disclosure further provide an alignment film composition, which includes a polyimide and an additive, wherein the additive includes a compound represented by formula I:

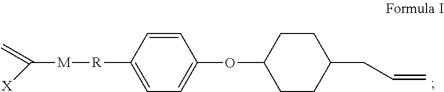

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

In some embodiments of the present disclosure, the additive includes at least one of the following compounds of Formula II and Formula III:

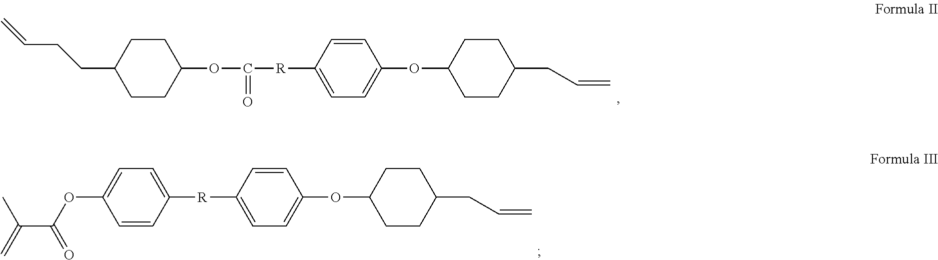

wherein the R includes at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms;
the M in the formula I is

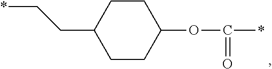 [SMILES: *CCC1CCC(OC(*)=O)CC1]

and the X is a hydrogen atom; or
the M in the formula 1 is

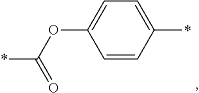 [SMILES: *C(=O)Oc1ccc(*)cc1]

and the X is methyl.

According to the above object of the present disclosure, some embodiments of the present disclosure further provides a method for manufacturing a display panel, including steps as follows:
providing a first substrate and a second substrate;
providing a polyimide alignment agent obtained from the alignment film composition mentioned above; and
forming a first alignment film and a second alignment film on the first substrate and the second substrate respectively by using the polyimide alignment agent.

According to the present disclosure, a functional group structure is formed in a first alignment film and a second alignment film. The functional group structure is similar to the structure of liquid crystal molecules in a liquid crystal layer, and the liquid crystal molecules have a large number of six-membered rings, so that the diffusivity and the dispersibility of the liquid crystal molecules can be improved, thereby improving distribution uniformity of the liquid crystal molecules, and thus improving the display effect of the display panel.

### BRIEF DESCRIPTION OF THE DRAWINGS

The technical solutions and other beneficial effects of the present disclosure will be apparent from the detailed description of specific embodiments of the present disclosure with reference to the accompanying drawings.

FIG. 1 is a flowchart of a method for manufacturing a display panel according to some embodiments of the present disclosure.

FIG. 2 is a schematic structural diagram of a display panel according to some embodiments of the present disclosure.

### DETAILED DESCRIPTION

Hereinafter, technical solution in embodiments of the present disclosure will be clearly and completely described with reference to the accompanying drawings in embodiments of the present disclosure. Obviously, the described embodiments are part of, but not all of, the embodiments of the present disclosure. All the other embodiments, obtained by a person with ordinary skill in the art on the basis of the embodiments in the present disclosure without expenditure of creative labor, belong to the protection scope of the present disclosure.

The following disclosure provides many different embodiments or examples for implementing different structures of the present disclosure. In order to simplify the disclosure of the present disclosure, components and arrangements of specific examples are described below. Of course, they are examples only and are not intended to limit the present disclosure. Furthermore, in the present disclosure, reference numbers and/or reference letters may be used repeatedly in different examples, such repetition is for sake of simplicity and clarity, which in itself does not indicate the relationship between the various embodiments and/or arrangements discussed. In addition, the present disclosure provides examples of various specific processes and materials, but one of ordinary skill in the art may recognize the application of other processes and/or the use of other materials.

Some embodiments of the present disclosure provide an alignment film composition including a polyimide and an additive, wherein the additive includes a compound represented by formula I:

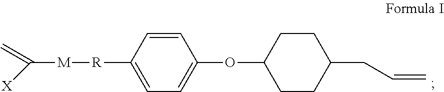

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

During the implementation and application process, according to the present disclosure, an additive having a structure represented by formula I is added to the alignment film composition. The structure of the additive is similar to the structure of liquid crystal molecules in a liquid crystal layer, and the liquid crystal molecules have a large number of six-membered rings, so that the diffusivity and the dispersibility of the liquid crystal molecules can be improved, thereby improving the distribution uniformity of the liquid crystal molecules, and thus improving the display effect of the display panel.

The embodiments of the present disclosure provide an alignment film composition, which includes a polyimide, a solvent, and an additive.

In some embodiments, the solvent may include at least one of N-methyl-2-pyrrolidone (NMP), N-ethyl-2-pyrrolidone (NEP), butyl cellosolve (BC), diethylene glycol diethyl ether (DEDG), and diacetone alcohol (DAA).

In the embodiments of the present disclosure, the alignment film composition further includes an additive, and the additive includes a compound represented by formula I:

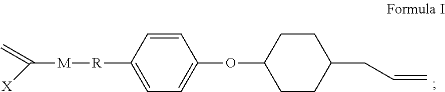

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

It should be noted that in the existing liquid crystal display panel, the liquid crystal molecules in the liquid crystal layer have a large number of six-membered rings, for example, six-membered rings as shown in the following formulas:

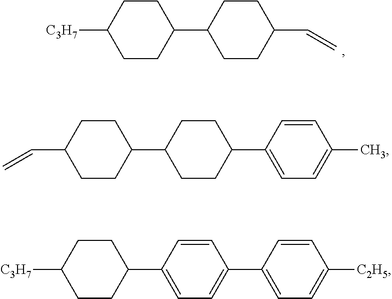

or the like.

Therefore, in the embodiments of the present disclosure, an additive having a structure represented by formula I is added to the alignment film composition. The structure of the additive is similar to that of the liquid crystal molecules in the liquid crystal layer, and the liquid crystal molecules have a large number of six-membered rings, such as phenyl groups and cyclohexyl groups, so that the diffusivity and the dispersibility of the liquid crystal molecules can be improved, thereby improving the distribution uniformity of the liquid crystal molecules, and thus improving the display effect of the display panel. In addition, the liquid crystal layer further includes a polymer network structure formed by cross-linking of monomers, and carbon-carbon double bonds are formed at both ends of the compound shown in the formula 1, which can further react with the monomers in the liquid crystal layer to facilitate the formation of the polymer network structure, thus improving the cross-linking degree of the polymer network structure, and further facilitating the improvement of the distribution uniformity of the liquid crystal molecules.

In some embodiments, M includes at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms. Preferably, the halogen atoms in the haloalkyl and haloalkoxy groups may include fluorine atoms.

Further, in some embodiments, the additive includes at least one of the following compounds of Formula II and Formula III:

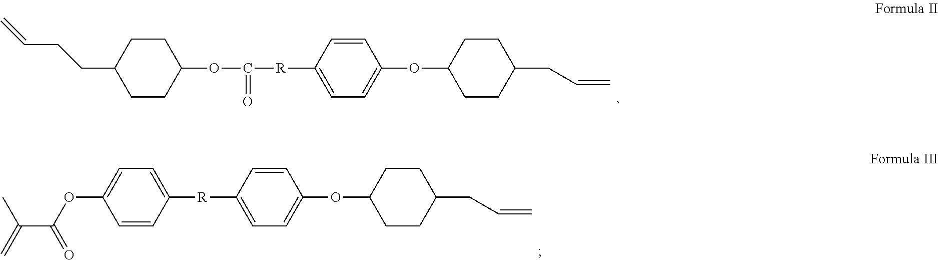

wherein M in the formula 1 is

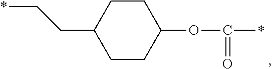 [SMILES: *CCC1CCC(OC(*)=O)CC1]

X is a hydrogen atom, which corresponds the structure as shown in the formula 2.

Optionally, M in the Formula 1 is

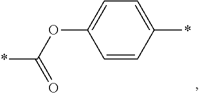 [SMILES: *C(=O)Oc1ccc(*)cc1]

X is methyl, which corresponds the structure as shown in the Formula 3.

Specifically, the additive may include at least one of the compounds as shown below:

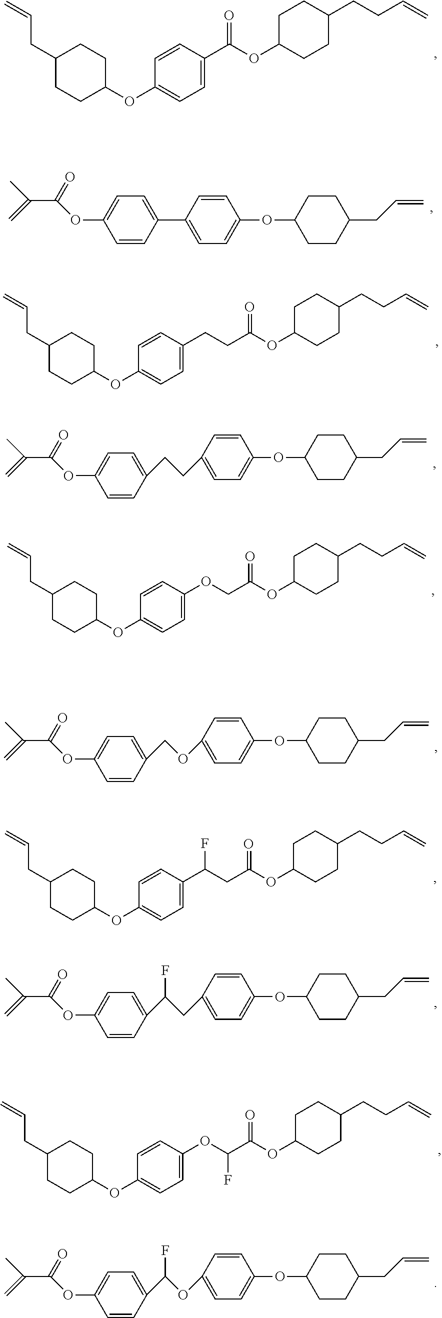

In some embodiments, the mass content of the additive in the alignment film composition is greater than or equal to 0.5% and less than or equal to 10%, for example, it can be 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%.

In some embodiments, the molar ratio of polyimide to solvent is 30:70.

As mentioned above, according to the present disclosure, as additive having a structure represented by formula I is added to the alignment film composition. The structure of the additive is similar to the structure of liquid crystal molecules in a liquid crystal layer, and the liquid crystal molecules have a large number of six-membered rings, such as phenyl groups and cyclohexyl groups, so that the diffusivity and the dispersibility of the liquid crystal molecules can be improved, thereby improving the distribution uniformity of the liquid crystal molecules, and thus improving the display effect of the display panel. In addition, the liquid crystal layer further includes a polymer network structure formed by cross-linking of monomers, and carbon-carbon double bonds are formed at both ends of the compound shown in the formula 1, which can further react with the monomers in the liquid crystal layer to facilitate the formation of the polymer network structure, thus further facilitating the improvement of the distribution uniformity of the liquid crystal molecules.

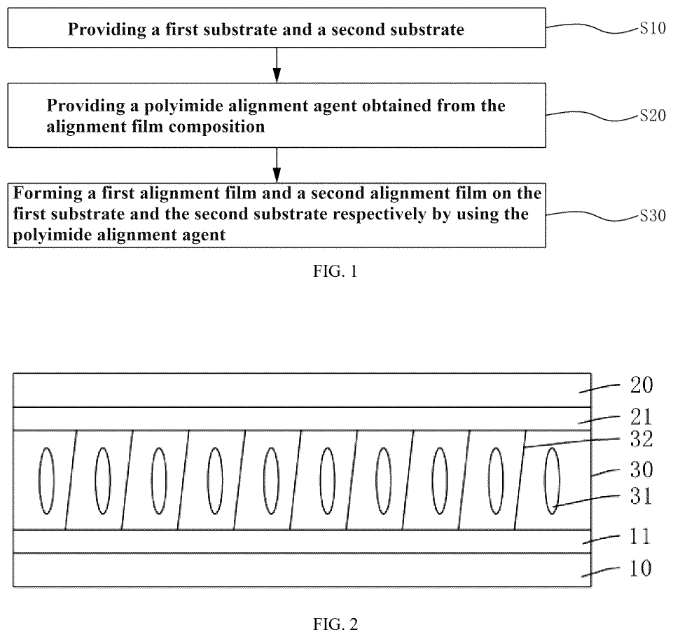

In addition, referring to FIGS. 1 and 2, some embodiments of the present disclosure further provide a method for manufacturing a display panel, which includes:
S10. providing a first substrate 10 and a second substrate 20;
S20. providing a polyimide alignment agent obtained from the alignment film composition mentioned above;
S30. forming a first alignment film 11 and a second alignment film 21 on the first substrate 10 and the second substrate 20 respectively by using the polyimide alignment agent.

Specifically, please continue to refer to FIGS. 1 and 2, in the step S10, the first substrate 10 and the second substrate 20 are provided. The first substrate 10 may be provided with a thin film transistor array layer, a pixel electrode, a common electrode on the array side, other signal lines, and the like. The second substrate 20 may be provided with a color film layer, a common electrode on the CF side, and the like.

In step S20, alignment film compositions as described in the above embodiments are provided, and a polyimide alignment agent is obtained from the alignment film compositions.

The alignment film composition includes a polyimide, a solvent, and an additive; wherein the polyimide is obtained by reacting a dianhydride compound and a diamine compound.

In some embodiments, the dianhydride compound may include at least one of cyclobutane-1,2,3,4-tetracarboxylic dianhydride (CBDA), and other aromatic dianhydride compounds, for example, may also include pyromellitic dianhydride, 2,3,6,7-naphthalene tetracarboxylic dianhydride, 1,2,5,6-naphthalene tetracarboxylic dianhydride, 1,4,5,8-naphthalene tetracarboxylic dianhydride, 2,3,6,7-anthracene-tetracarboxylic dianhydride, 1,2,5,6-anthracene-tetracarboxylic dianhydride, 3,3′,4,4′-benzophenone-tetracarboxylic dianhydride, 2,2′,3,3′-benzophenone-tetracarboxylic dianhydride, 2,3,3′,4′-benzophenone-tetracarboxylic dianhydride, 3,3′,4,4′-benzophenonetetracarboxylic acid dianhydride, 2,3,3′,4′-benzophenonetetracarboxylic acid dianhydride, bis(3,4-dicarboxyphenyl) methane dianhydride, bis(3,4-dicarboxyphenyl) ether dianhydride, bis(3,4-dicarboxyphenyl) sulfone dianhydride, 2,2-bis(3,4-dicarboxyphen-yl) propane dianhydride, 2,2-bis(3,4-dicarboxyphen-yl) hexafluoropropane dianhydride, 2,5-dicarboxymethyl terephthalic dianhydride, 4,6-dicarboxymethyl isophthalic dianhydride, 4-(2,5-dioxotetrahydro-3-furanyl) phthalic anhydride, 1,4-bis(2, 5-dioxotetrahydro-3-furyl)benzene, 1, 4-bis(2,6-dioxotetrahydro-4-pyranyl)benzene, 1, 4-bis(2,5-dioxotetrahydro-3-methyl-3-furanyl)benzene, 1, 4-bis(2,6-dioxotetrahydro-4-methyl-4-pyranyl)benzene, 1,2,3,4,-butanetetracarboxylic dianhydride, 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 2,3,4,5-tetrahydrofuranetetracarboxylic dianhydride, 2,3,5-tricarboxycyclopentylacetic acid dianhydride, 1,2,4,5-cyclohexanetetracarboxylic dianhydride, 4-(2,5-dioxotetrahydro-3-furanyl)-cyclohexane-1,2-dicarboxylic anhydride, 5-(2,5-dioxotetrahydro-3-furanyl)-3-methyl-3-cyclohexene-1,2-dicarboxylic anhydride, bicyclo-[2.2.2]oct-7-ene-2,3,5,6-tetracarboxylic acid dianhydride, 3,4-dicarboxy-1,2,3,4-tetrahydro-1-naphthalene succinic dianhydride, 3,4-dicarboxy-1,2,3,4-tetrahydro-6-methyl-1-naphthalene succinic dianhydride, bicyclo[3.3.0]octane-2,4,6,8-tetracarboxylic dianhydride, 3,3′, 4,4′-dicyclohexyltetracarboxylic dianhydride, 2,3,5,6-norbornane tetracarboxylic dianhydride, 3,5,6-tricarboxynorbornane-2-acetic dianhydride, tricyclo[4.2.1.02,5]nonane-3,4,7,8-tetracarboxylic dianhydride, tetracyclo[4.4.1.02,5.07,10]undecane-3,4,8,9-tetracarboxylic dianhydride, hexacyclo[6.6.0.12,7.03,6.19, 14.010, 13]hexadecane-4,5, 11, 12-tetracarboxylic dianhydride.

In some embodiments, the diamine compound includes at least one of diaminodiphenylmethane (MDA), 1,3-diamino-4-{4-[trans-4-(trans-4-n-pentylcyclohexyl)cyclohexyl]phenoxy}benzene (PBCH5DAB), and other aromatic diamine compounds, and may include, for example, p-phenylenediamine, m-phenylenediamine, 2,4-diaminotoluene, 2,5-diaminotoluene, 2,6-diaminotoluene, 2,4-dimethyl-1,3-diaminobenzene, 2,5-dimethyl-1,4-diaminobenzene, 2,3,5,6-tetramethyl-1,4-diaminobenzene, 2,4-diaminophenol, 2,5-diaminophenol, 4,6-diaminoresorcinol, 2,5-diaminobenzoic acid, 3,5-diaminobenzoic acid, N,N-diallyl-2,4-diaminoaniline, N,N-diallyl-2,5-diaminoaniline, 4-aminobenzylamine, 3-aminobenzylamine, 2-(4-aminophenyl)ethylamine, 2-(3-aminophenyl)ethylamine, 1,5-naphthalenediamine, 2,7-naphthalenediamine, 4,4′-diaminobiphenyl, 3,4′-diaminobiphenyl, 3,3′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dicarboxy-4,4′-diaminobiphenyl, 3,3′-difluoro-4,4′-diaminobiphenyl, 2,2′-trifluoromethyl-4,4′-diaminobiphenyl, 3,3′-trifluoromethyl-4,4′-diaminobiphenyl, 4,4′-diaminodiphenylmethane, 3,3′-diaminodiphenylmethane, 3,4′-diaminodiphenylmethane, 4,4′-diaminodiphenyl ether, 3,3′-diaminodiphenyl ether, 3,4′-diaminodiphenyl ether, 4,4′-diaminodiphenyl sulfone, 3,3′-diaminodiphenyl sulfone, 4,4′-diaminodiphenylamine, 3,3′-diaminodiphenylamine, 3,4′-diaminodiphenylamine, N-methyl (4,4′-diaminodiphenyl)amine, N-methyl (3,3′-diaminodiphenyl)amine, N-methyl (3,4′-diaminodiphenyl)amine, 4,4′-diaminobenzophenone, 3,3′-diaminobenzophenone, 3,4′-diaminobenzophenone, 4,4′-diaminobenzophenone, 4,4′-diamino-N-benzoanilide, 1,2-bis(4-aminophenyl) cthanc, 1,2-bis(3-aminophenyl) ethane, 4,4′-diaminodiphenylacetylene, 1,3-bis(4-aminophenyl) propane, 1,3-bis(3-aminophenyl) propane, 2,2-bis(4-aminophenyl) propane, 2,2-bis(3-aminophenyl) propane, 2,2-bis(3-amino-4-methylphenyl) propane, 2,2-bis(4-aminophenyl) hexafluoropropane, 2,2-bis(3-aminophenyl) hexafluoropropane, 2,2-bis(3-amino-4-methylphenyl) hexafluoropropane, 1,3-bis(4-aminophenoxy) propane, 1,4-bis(4-aminophenoxy) butane, 1,5-bis(4-aminophenoxy) pentane, 1,6-bis(4-aminophenoxy) hexane, 1,7-bis(4-aminophenoxy) heptane, 1,8-bis(4-aminophenoxy) octane, 1,9-bis(4-aminophenoxy) nonanc, 1,10-bis(4-aminophenoxy) decanc, 1,11-bis(4-aminophenoxy) undecane, 1,12-bis(4-aminophenoxy) dodecane, bis(4-aminophenyl) malonate, bis(4-aminophenyl) succinate, bis(4-aminophenyl) glutarate, bis(4-aminophenyl) adipate, bis(4-aminophenyl) pimelate, bis(4-aminophenyl) octanedioate, bis(4-aminophenyl) azelate, bis(4-aminophenyl) scbacate, 1,4-bis(4-aminophenyl)benzene, 1,3-bis(4-aminophenyl)benzene, 1,4-bis(4-aminophenoxy)benzene, 1,3-bis(4-aminophenoxy)benzene, 1,4-bis(4-aminobenzyl)benzene, 1,3-bis(4-aminobenzyl)benzene, bis(4-aminophenyl) terephthalate, bis(3-aminophenyl) terephthalate, bis(4-aminophenyl) isophthalate, bis(3-aminophenyl) isophthalate, 1,4-phenylene bis [(4-aminophenyl) methanone], 1,4-phenylene bis [(3-aminophenyl) methanone], 1,3-phenylene bis [(4-aminophenyl) methanone], 1,3-phenylene bis [(3-aminophenyl) methanone], 1,4-phenylene bis(4-aminobenzoate), 1,4-phenylene bis(3-aminobenzoate), 1,3-phenylene bis(4-aminobenzoate), 1,3-phenylene bis(3-aminobenzoate), N,N′-(1,4-phenylene)bis(4-aminobenzamide), N,N′-(1,3-phenylene)bis(4-aminobenzamide), N,N′-(1,4-phenylene)bis(3-aminobenzamide), N,N′-(1,3-phenylene)bis(3-aminobenzamide), bis(4-aminophenyl) terephthalamide, bis(3-aminophenyl) terephthalamide, bis(4-aminophenyl) isophthalamide, bis(3-aminophenyl) isophthalamide, 2,2-bis [4-(4-aminophenoxy)phenyl]propane, 2,2-bis [4-(4-aminophenoxy)phenyl]hexafluoropropane, 4,4′-bis(4-aminophenoxy)diphenyl sulfone, 2,6-diaminopyridine, 2,4-diaminopyridine, 2,4-diamino-1,3,5-triazine, 2,6-diaminodibenzofuran, 2,7-diaminodibenzofuran, 3,6-diaminodibenzofuran, 2,6-diaminocarbazole, 2,7-diaminocarbazole, 3,6-diaminocarbazole, 2,4-diamino-6-isopropyl-1,3,5-triazine, 2,5-bis(4-aminophenyl)-1,3,4-oxadiazole, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,4-diaminocyclohexane, 1,3-diaminocyclohexane, bis(4-aminocyclohexyl) methane, bis(4-amino-3-methylcyclohexyl) methane.

In this embodiment, a dianhydride compound and a diamine compound are mixed and reacted, wherein the dianhydride compound includes 1,2,3,4-cyclobutane tetracarboxylic dianhydride, the diamine compound includes diaminodiphenylmethane and 1,3-diamino-4-{4-[trans-4-(trans-4-n-pentylcyclohexyl)cyclohexyl]phenoxy}benzene.

In some embodiments, the molar ratio of the dianhydride compound to the diamine compound is 1:1.

Specifically, 1,2,3,4-tetracarboxylic dianhydride, diaminodiphenylmethane, and 1,3-diamino-4-{4-[trans-4-(trans-4-n-pentylcyclohexyl)cyclohexyl]phenoxy}benzene in a molar ratio of 50:20:30 are mixed into a N-methylpyrrolidone solution, and reacted at 25° C. for 4 hours to obtain a polyamic acid solution. Further, N-methylpyrrolidone is added therein to dilute the polyamic acid solution to about 6%, and an appropriate amount of acetic anhydride and a pyridine catalyst are added to react at 100° C. for 3 hours to obtain a solution. Then the solution is added to methanol to obtain polyimide white powders.

A dehydrating agent and a catalyst (or a dehydration ring-closing catalyst) may also be added during the preparation of the polyimide. The dehydrating agent may include an anhydride such as acetic anhydride, propionic anhydride, trifluoroacetic anhydride, or the like. In this embodiment, acetic anhydride is used as the dehydrating agent. The catalyst may include a pyridine catalyst, for example, a tertiary amine such as pyridine, N-methylpiperidine, trimethylpyridine, dimethylpyridine, triethylamine, or the like. The dianhydride compound and the diamine compound react to obtain the polyamic acid, and the amount of the dehydrating agent used is preferably 0.01 mol to 20 mol with respect to 1 mol of the amide acid structure of the polyamic acid, and the amount of the catalyst used is preferably 0.01 mol to 10 mol with respect to 1 mol of the dehydrating agent used.

Then, the polyimide white powders are added to a solvent of N-methyl-2-pyrrolidone, N-ethyl-2-pyrrolidone, butyl cellosolve, diethylene glycol diethyl ether, and diacetone alcohol to obtain an initial polyimide alignment agent.

In some embodiments, the molar ratio of polyimide, N-methyl-2-pyrrolidone, N-ethyl-2-pyrrolidone, butyl cellosolve, diethylene glycol diethyl ether, and diacetone alcohol is 30:15:35:10:10.

Next, an additive such as

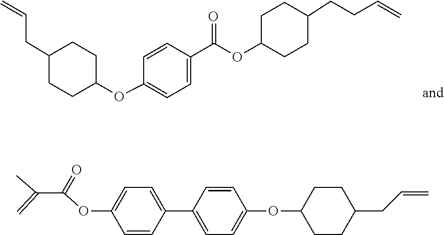

as described in the above embodiments is provided.

The synthesis of

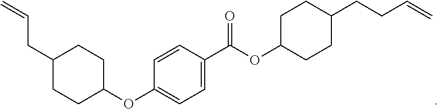 [SMILES: C=CCCC1CCC(OC(=O)c2ccc(OC3CCC(CC=C)CC3)cc2)CC1]

includes:

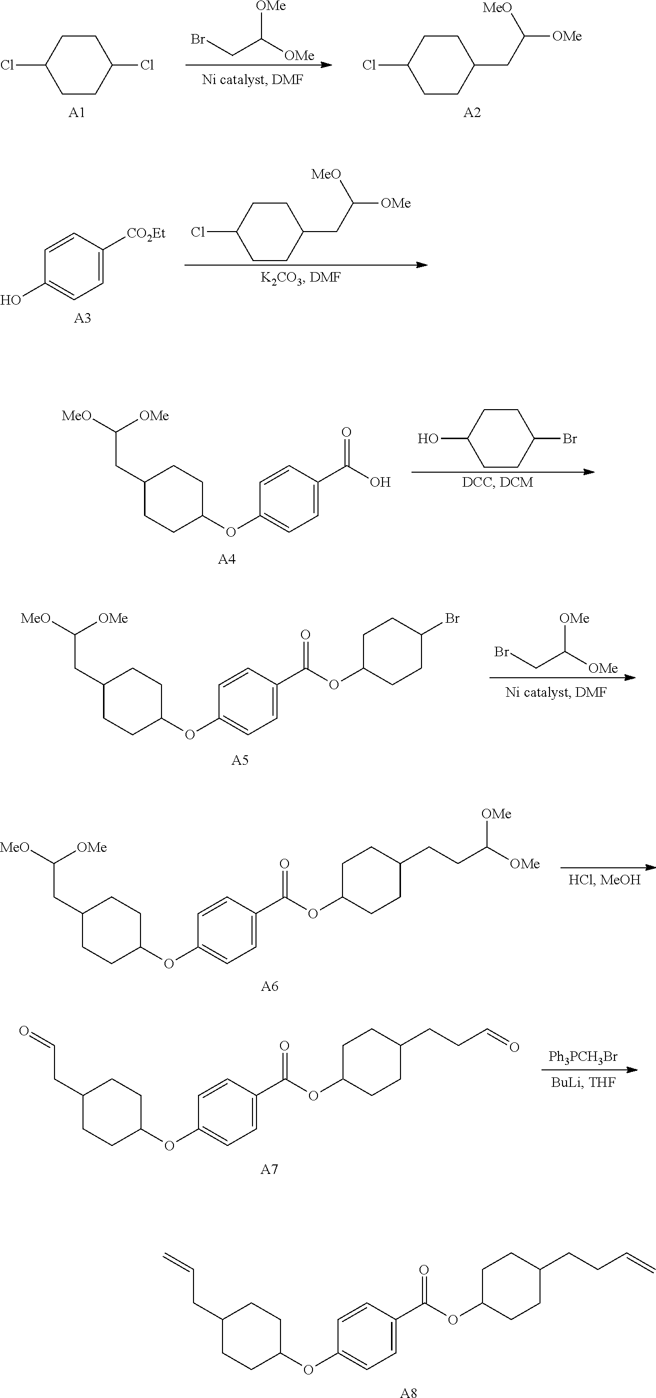

Specifically, the synthesis steps from A1 to A2 are as follows:

Ni (1 mmol, 0.5 mmol %) catalyst is added into a round-bottom flask, and air in the flask is replaced with N₂ for three times. 1,4-dichlorocyclohexane (200 mmol, 1 equiv) and 2-bromo-1,1-dimethoxyethane (240 mmol, 1.2 equiv) are dissolved in DMF, respectively, and successively injected into the flask under N₂ atmosphere and reacted at 80° C. overnight. After the reaction is completed, saturated NaCl solution is added to quench the reaction, followed by stripping with EA, washing with saturated NaCl, drying with Na₂SO₄, rotary evaporating to dryness and separating through a silica gel column to obtain product A2 with a yield of 61%.

Synthesis steps from A3 to A4 are as follows:

A2 (122 mmol, 1 equiv), ethyl-4-hydroxybenzoate (147 mmol, 1.2 equiv), and K₂CO₃ (244 mmol, 2 equiv) are added to a round-bottom flask under N₂ atmosphere, and DMF is injected to carry out a reaction at 60° C. for 6 hours. After the reaction is completed, saturated NaCl solution is added to quench the reaction, followed by stripping with EA, drying with Na₂SO₄, washing with saturated NaCl, rotary evaporating to dryness and separating through a silica gel column to obtain product A4 with a yield of 66%.

Synthetic steps from A4 to A5 are as follows:

A4 (81 mmol, 1 equiv) and DCC (122 mmol, 1.5 equiv) are added into a round-bottom flask, after air in the flask is replaced by N₂ for three times, 20 mL DCM is added. 4-Bromocyclohexanol (98 mmol, 1.2 equiv) is dissolved in 40 mL DCM, and added dropwise at 0° C. to carry out a reaction at room temperature for 6 hours. After the reaction is completed, rotary evaporating is directly carried out to dry the solvent, followed by separating through a silica gel column to obtain product A5 with a yield of 86%.

Synthetic steps from A5 to A6 are as follows:

A5 (70 mmol, 1 equiv), Ni catalyst (0.35 mmol, 0.5 mmol %) are added to a round-bottom flask, and air in the flask is replaced by N₂ for three times. 1-Bromo-3,3-dimethoxypropane (84 mmol, 1.2 equiv) is dissolved in DMF and added to the flask to carry out a reaction at 80° C. overnight. After the reaction is completed, saturated NaCl solution is added to quench the reaction, followed by stripping with EA, washing with saturated NaCl, drying with Na₂SO₄, rotary evaporating to dryness and separating through a silica gel column to obtain product A6 with a yield of 42%.

Synthetic steps from A6 to A7 are as follows:

A6 (29 mmol, 1 equiv) is added into a round-bottom flask, after air in the flask is replaced by N₂ for three times, 20 mL MeOH and concentrated HCl (145 mmol, 5 equiv) are added to carry out a reaction at room temperature overnight. After the reaction is completed, cold saturated NaHCO₃ solution is added to quench the reaction, followed by stripping with EA, washing with NaCl, drying with Na₂SO₄, rotary evaporating to dryness and separating through a silica gel column to obtain product A7 with a yield of 37%.

Synthetic steps from A7 to A8 are as follows:

A7 (11 mmol, 1 equiv) is added into a round-bottom flask, and air in the flask is replaced by N₂ for three times. 10 mL THF is added, and n-BuLi (11.6 mmol, 1.05 equiv) is slowly added dropwise at −78° C. for 30 min, then a THF solution of methyltriphenylphosphonium bromide is slowly added dropwise at 0° C. for 2 hours. After completion of the reaction, H₂O is added to quench the reaction, followed by stripping with EA, washing with saturated NaCl, drying with Na₂SO₄, rotary evaporating to dryness and separating through a silica gel column to obtain product A8 with a yield of 33%.

Furthermore, the synthesis of

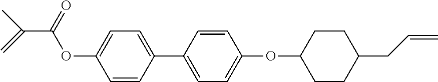 [SMILES: C=CCC1CCC(Oc2ccc(-c3ccc(OC(=O)C(=C)C)cc3)cc2)CC1]

includes:

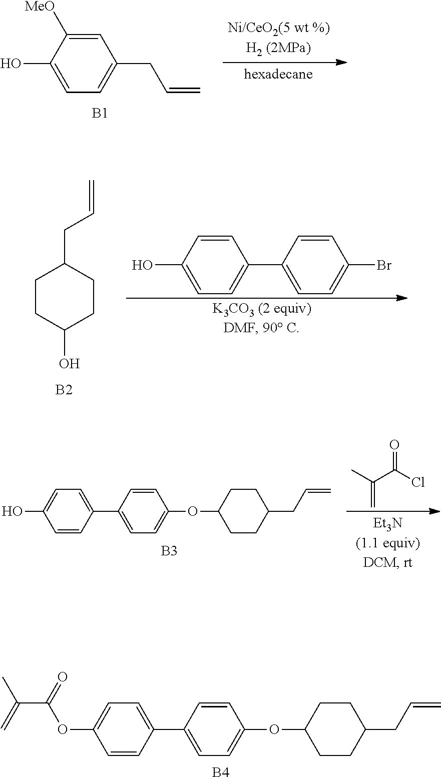

Specifically, the steps for synthesizing the compound includes: adding eugenol (B1) into a first reactor, and adding a mesoporous 5 wt % Ni/CeO₂ catalyst and n-hexadecane therein to carry out a reaction under a hydrogen atmosphere at 2 MPa to obtain B2 with a yield of 80%.

Then, adding B2, 4-hydroxy-4′-bromobiphenyl, 2 equivalents of K₃CO₃ and N,N-dimethylformamide solvent into a second reactor to carry out a reaction at 90° C. to obtain B3 with a yield of 77%.

Subsequently, adding B3, methacryloyl chloride, 1.1 equivalents of triethylamine, and dichloromethane solvent to into a third reactor to carry out a reaction at room temperature to obtain B4 with a yield of 84%.

Adding at least one of

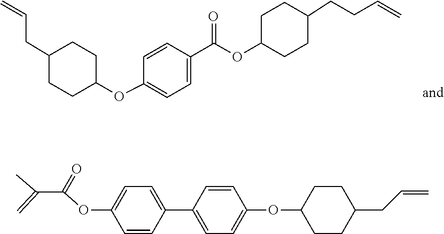

into the initial polyimide alignment agent to form a polyimide alignment agent.

It should be noted that after adding the additive, the physical properties of the polyimide alignment agent, such as viscosity, can also be adjusted according to actual needs, for example, other solvents are added into polyimide alignment agent according to a preset ratio for mixing, so as to adjust the viscosity and solid content of polyimide alignment agent.

In some embodiments, the polyimide in the polyimide alignment agent has a solid content of 3.5% and a viscosity of 7 cP.

In step S30, a first alignment film 11 and a second alignment film 21 are formed on the first substrate 10 and the second substrate 20 respectively by using the polyimide alignment agent.

That is, the first alignment film 11 is formed by spin coating polyimide alignment agent on the first substrate 10, and the second alignment film 21 is formed by spin coating polyimide alignment agent on the second substrate 20.

Specifically, the first film and the second film are formed on the first substrate 10 and the second substrate 20 respectively by spin coating polyimide alignment agent, which are baked on a hot plate at 80° C. for 120s, and then baked on a hot air circulating furnace at 185° C. for 1200s to obtain a first alignment intermediate film on the first substrate 10 and a second alignment intermediate film on the second substrate 20.

In some embodiments, the thickness of the first alignment intermediate film and the thickness of the second alignment intermediate film may be 100 nm±5 nm.

A frame glue doped with silicon balls is coated on the periphery of the first substrate 10 by using a glue coater, liquid crystals are dropped on the surface of the first substrate 10 by using a pipette, and the first substrate 10 and the second substrate 20 are matched as a group for 2 minutes at 120° C. by using a hot press. Finally, UV light is irradiated to the first substrate 10 and the second substrate 20 to complete the alignment, so that the first alignment film 11 is formed on the first substrate 10 and the second alignment film 21 is formed on the second substrate 20.

In some embodiments, the particle size of the silicon ball may be 3.6 μm, and a 5×5 matrix liquid crystal is formed on the surface of the first substrate 10. One side of the first substrate 10 provided with the first alignment intermediate film is disposed opposite to one side of the second substrate 20 provided with the second alignment intermediate film. The first alignment intermediate film is oriented to form the first alignment film 11, and the second alignment intermediate film is oriented to form the second alignment film 21.

The display panel further includes a liquid crystal layer 30 disposed between the first substrate 10 and the second substrate 20. The liquid crystal layer 30 includes liquid crystal molecules 31, and the liquid crystal molecules 31 include at least one six-membered ring, such as phenyl groups and cyclohexyl groups. In the embodiments according to the present disclosure, an additive having a structure represented by formula I is added to the alignment film composition. The structure of the additive is similar to the structure of liquid crystal molecules 31 in a liquid crystal layer 30, and the liquid crystal molecules 30 have a large number of six-membered rings, such as phenyl groups and cyclohexyl groups, so that the diffusivity and the dispersibility of the liquid crystal molecules 31 can be improved, thereby improving the distribution uniformity of the liquid crystal molecules 31, and thus improving the display effect of the display panel.

In addition, the liquid crystal layer 30 further includes a polymer network structure 32 connected to the first alignment film 11 and/or the second alignment film 21, wherein carbon-carbon double bonds are formed at both ends of the compound shown in the formula 1, so that the carbon-carbon double bonds can be opened and react with the monomers in the liquid crystal layer 30 to facilitate the formation of the polymer network structure 32, so that the formed polymer network structure 32 is connected to the first alignment film 11 and the second alignment film 21, thereby improving the cross-linking degree, and further facilitating the improvement of the distribution uniformity of the liquid crystal molecules 31.

Furthermore, in the embodiments of the present disclosure, in order to verify the effect of the additives on improving the distribution uniformity of the liquid crystal molecules 31, the display panel manufactured by the method for manufacturing the display panel described above is verified.

The present disclosure provides fifteen embodiments for verification, and the difference among the fifteen embodiments lies in whether there are additives in the polyimide alignment agent in the step S20, or the content of the additives.

It should be noted that in the above-mentioned embodiments 1 to 15, the specific substances and contents of the dianhydride compound and the diamine compound remain unchanged during the preparation process of the polyimide aligning agents, and the preparation can be carried out with reference to the above-mentioned embodiments, while the mass content of the polyimide is 3.5%, and only the content of the additives and the content of the solvents are changed, that is, after the content of the additives in each embodiment is confirmed, the remaining component is the solvent.

Specifically, no additives are added to the polyimide alignment agent in embodiment 1.

The additive in the polyimide alignment agent in embodiments 2 to 8 is the compound as follows:

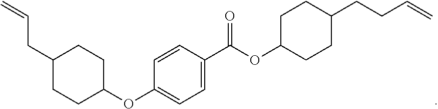 [SMILES: C=CCCC1CCC(OC(=O)c2ccc(OC3CCC(CC=C)CC3)cc2)CC1]

The mass content of the additives in the polyimide alignment agent in embodiment 2 is 0.1%.

The mass content of the additive in the polyimide alignment agent in embodiment 3 is 0.3%.

The mass content of the additive in the polyimide alignment agent in embodiment 4 is 0.5%.

The mass content of the additive in the polyimide alignment agent in embodiment 5 is 1.0%.

The mass content of the additive in the polyimide alignment agent in embodiment 6 is 3%.

The mass content of the additive in the polyimide alignment agent in embodiment 7 is 5%.

The mass content of the additive in the polyimide alignment agent in embodiment 8 is 10%.

The additive in the polyimide alignment agent in embodiments 9 to 15 is the compound as follows:

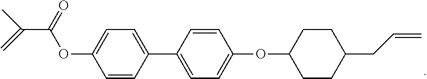 [SMILES: C=CCC1CCC(Oc2ccc(-c3ccc(OC(=O)C(=C)C)cc3)cc2)CC1]

The mass content of the additive in the polyimide alignment agent in embodiment 9 is 0.1%.

The mass content of the additive in the polyimide alignment agent in embodiment 10 is 0.3%.

The mass content of the additive in the polyimide alignment agent in embodiment 11 is 0.5%.

The mass content of the additive in the polyimide alignment agent in embodiment 12 is 1.0%.

The mass content of the additive in the polyimide alignment agent in embodiment 13 is 3%.

The mass content of the additive in the polyimide alignment agent in embodiment 14 is 5%.

The mass content of the additive in the polyimide alignment agent in embodiment 15 is 10%.

Next, the display panels in embodiments 1 to 15 are continuously illuminated for 72 hours under a direct current of 5 V, and then the Drop Mura condition is verified under an orthogonal polarizer, and the results as shown in Table 1 below are obtained.

TABLE 1
Verification results

| | Drop Mura level |
|---|---|
| Embodiment 1 | x |
| Embodiment 2 | x |
| Embodiment 3 | Δ |
| Embodiment 4 | ∘ |
| Embodiment 5 | ∘ |
| Embodiment 6 | ∘ |
| Embodiment 7 | ∘ |
| Embodiment 8 | ∘ |
| Embodiment 9 | x |
| Embodiment 10 | x |
| Embodiment 11 | Δ |
| Embodiment 12 | Δ |
| Embodiment 13 | ∘ |
| Embodiment 14 | ∘ |
| Embodiment 15 | ∘ |

As shown in Table I above, wherein “x” indicates poor, “A” indicates medium, and “0” indicates good. It can be seen from Table 1 that the Drop Mura phenomenon can be significantly improved by adding a certain amount of additive to the polyimide alignment agent. In a case that the mass content of the additive in the polyimide alignment agent is greater than or equal to 0.5% and less than or equal to 10%, the Drop Mura phenomenon of the display panel can be effectively improved. Furthermore, it has been verified in the embodiments of the present disclosure that in a case that the content of the additive in the polyimide alignment agent is greater than 10%, there will be too many small molecular structures in the polyimide alignment agent, which will result in poor film-forming uniformity of the alignment film finally obtained.

It can be understood that, in addition to the structure of the additive described in embodiments 1 to 15, when M, R, and X are other groups, since the corresponding additive also contains more six-membered rings and carbon-carbon double bonds on both sides of the additive, it is also possible to improve the diffusivity and dispersibility of the liquid crystal molecules 31 when M, R, and X are other groups, the diffusivity and dispersibility of the liquid crystal molecules 31 can also be improved, thereby improving the distribution uniformity of the liquid crystal molecules 31 and improving the Drop Mura phenomenon of the display panel.

In summary, in the embodiments of the present disclosure, an additive having a structure represented by formula I is added to the alignment film composition. The structure of the additive is similar to that of the liquid crystal molecules 31 in the liquid crystal layer 30, and the liquid crystal molecules 31 have a large number of six-membered rings, such as phenyl groups and cyclohexyl groups, so that the diffusivity and the dispersibility of the liquid crystal molecules 31 can be improved, thereby improving the distribution uniformity of the liquid crystal molecules 31, and thus improving the display effect of the display panel. In addition, the liquid crystal layer 30 further includes a polymer network structure 32 formed by cross-linking of monomers, and carbon-carbon double bonds are formed at both ends of the compound shown in the formula 1, which can further react with the monomers in the liquid crystal layer 30 to facilitate the formation of the polymer network structure, thus improving the cross-linking degree of the polymer network structure 32, and further facilitating the improvement of the distribution uniformity of the liquid crystal molecules 31, thereby effectively improving the Drop Mura phenomenon of the display panel.

In addition, some embodiments of the present disclosure further provide a display panel. Referring to FIG. 2, the display panel includes a first substrate 10 and a second substrate 20 that are oppositely disposed, a first alignment film 11 disposed on a side of the first substrate 10 close to the second substrate 20, and a second alignment film 21 disposed on a side of the second substrate 20 close to the first substrate 10. Each of the first alignment film 11 and the second alignment film 21 includes at least one of the following functional groups:

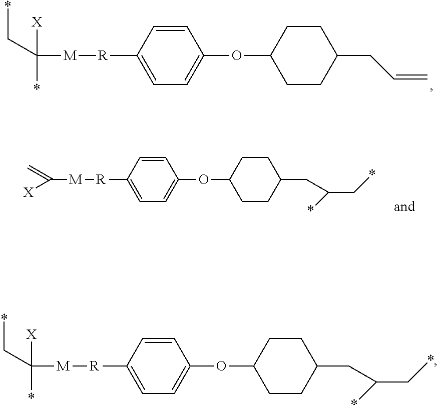

wherein M includes a six-membered ring, and R includes at least one of a single bond, a substituted or an unsubstituted alkyl group, and a substituted or an unsubstituted alkoxy group, and X includes one of a hydrogen atom, and a substituted or an unsubstituted alkyl group.

During the implementation and application process, in the display panel provided in the embodiments of the present disclosure, the first alignment film 11 and the second alignment film 21 have a large number of six-membered rings, such as phenyl groups and cyclohexyl groups, whose structures are similar to those of the liquid crystal molecules, so that the diffusivity and the dispersibility of the liquid crystal molecules can be improved, thereby improving the distribution uniformity of the liquid crystal molecules, and thus improving the display effect of the display panel.

It should be noted that the functional group structures in the first alignment film 11 and the second alignment film 21 are derived from the additives in the alignment film composition described in the above embodiments. Specifically, at least one of the carbon-carbon double bonds on both sides of the additives in the above embodiments is opened; and the “*” in the above functional group structure indicates a linking site or a fusing site.

In some embodiments, M includes at least one of a phenyl group and a cyclohexyl group; R includes at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms.

In some embodiments, M includes and one of

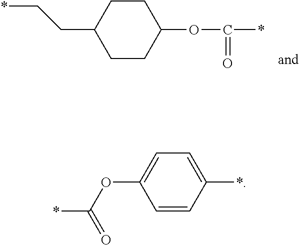

In some embodiments, each of the first alignment film 11 and the second alignment film 21 includes at least one of the following functional group structures:

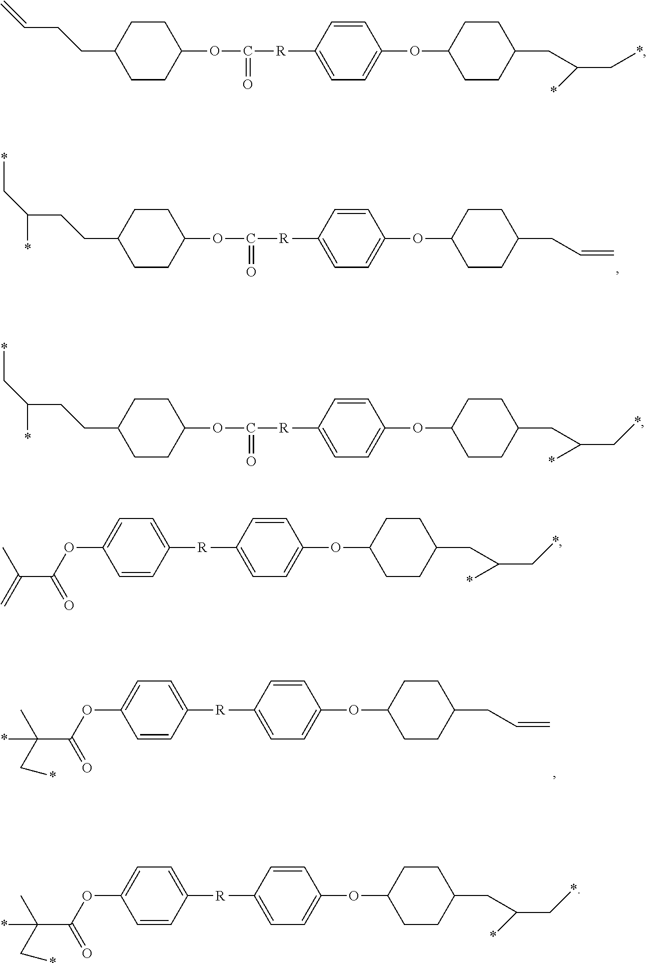

Furthermore, each of the first alignment film 11 and the second alignment film 21 include at least one of the following functional group structures:

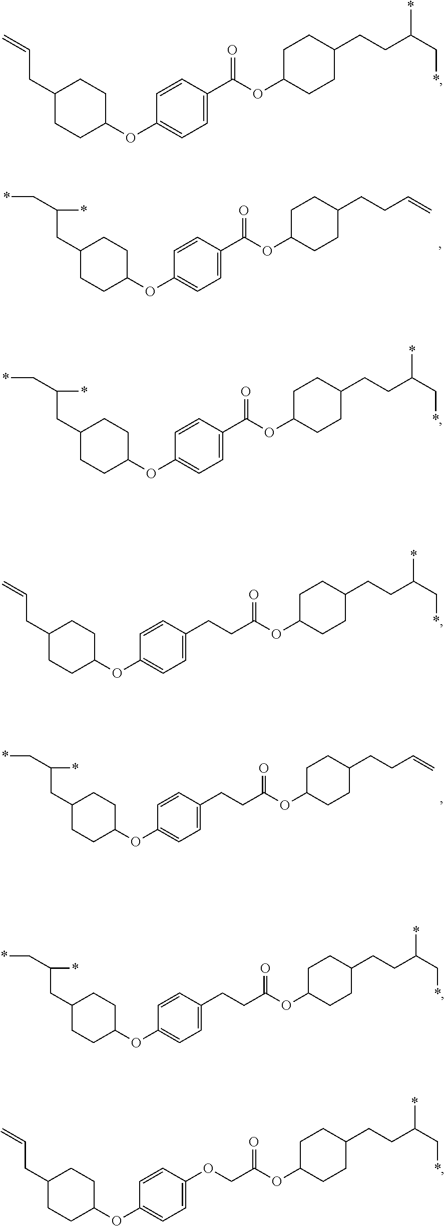

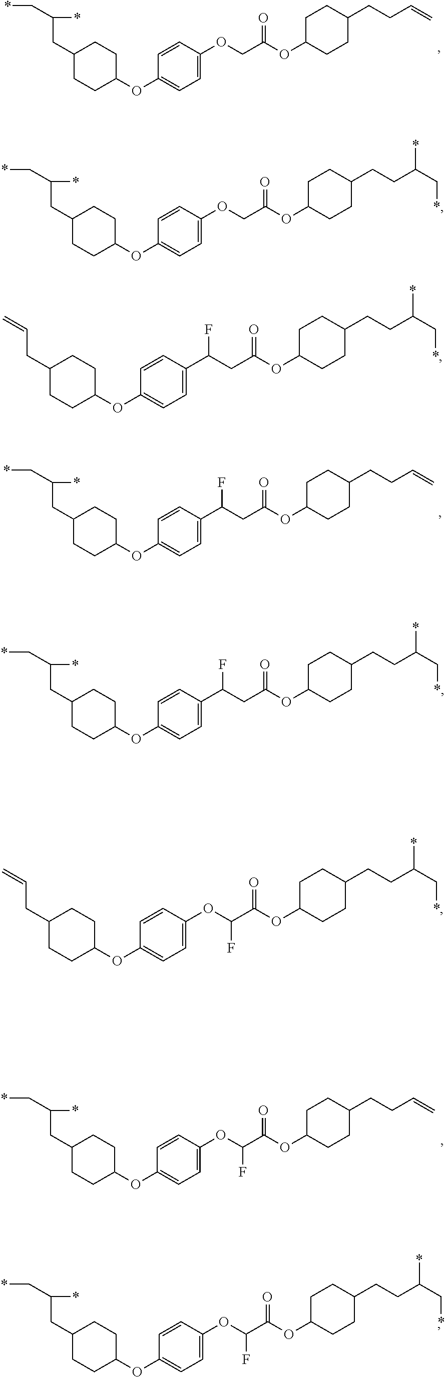

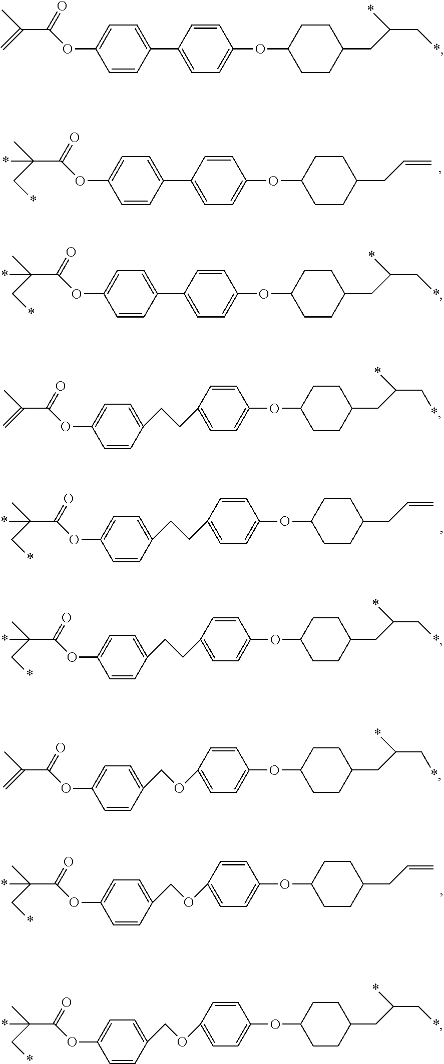

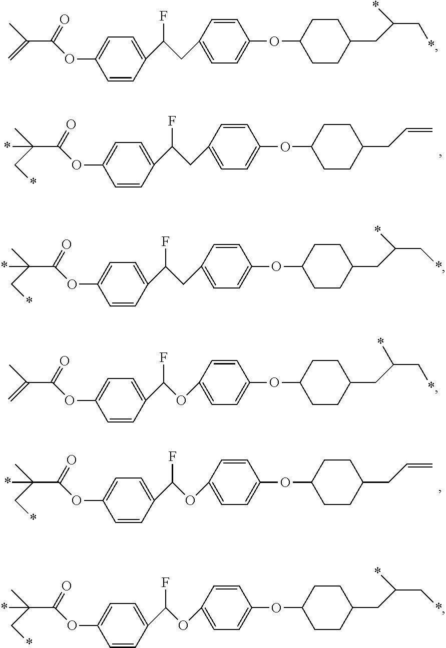

It can be understood that both the first alignment film 11 and the second alignment film 21 may be obtained by using the alignment film composition as described in the above-described embodiments, and the display panel may be manufactured by using the method for manufacturing the display panel as described in the above-described embodiments.

Furthermore, the display panel further includes a liquid crystal layer 30 disposed between the first alignment film 11 and the second alignment film 21. The liquid crystal layer 30 includes liquid crystal molecules 31. It should be noted that the liquid crystal molecules 31 include at least one six-membered ring, such as a phenyl group and a cyclohexyl group, for example, structural formula as follows:

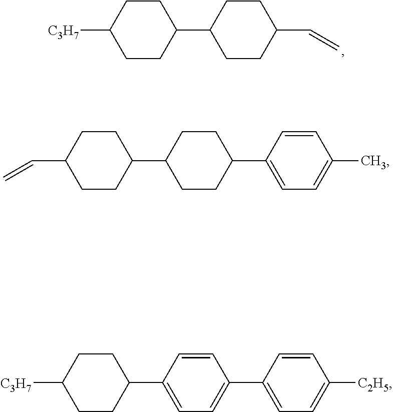

or the like.

Therefore, in the embodiments of the present disclosure, a functional group structure is formed in both the first alignment film 11 and the second alignment film 21, and the functional group structure is similar to the structure of the liquid crystal molecules 31 in the liquid crystal layer 30. The liquid crystal molecules 31 have a large number of six-membered rings, such as phenyl groups and cyclohexyl groups, so that the diffusivity and the dispersibility of the liquid crystal molecules 31 can be improved, thereby improving distribution uniformity of the liquid crystal molecules 31, and thus improving the display effect of the display panel.

The liquid crystal layer 30 further includes a polymer network structure 32 connected to the first alignment film 11 and/or the second alignment film 21, wherein carbon-carbon double bonds are formed at both ends of the compound shown in the formula 1, so that the carbon-carbon double bonds can be opened and react with the monomers in the liquid crystal layer 30 to facilitate the formation of the polymer network structure 32, so that the formed polymer network structure 32 is connected to the first alignment film 11 and the second alignment film 21, thereby improving the cross-linking degree, and further facilitating the improvement of the distribution uniformity of the liquid crystal molecules 31.

In the above-mentioned examples, the description of each example has its own focus. For parts that are not described in detail in an example, please refer to related descriptions of other examples.

In view of the foregoing, the alignment film composition, display panel, and method for manufacturing the same provided in examples of the present disclosure have been described in detail above, and the principles and embodiments of the present disclosure are described by using specific examples herein. Descriptions of the above examples are merely intended to help understand the technical solutions and core ideas of the present disclosure. A person with ordinary skill in the art should understand that various modifications may still be made to the technical solutions described in the foregoing examples, or equivalents may be made to some of the technical features therein. These modifications or substitutions do not depart the essence of the corresponding technical solutions from the scope of the technical solutions of the examples of the present disclosure.

What is claimed is:

1. An alignment film composition comprising a polyimide and an additive, wherein the additive comprises a compound represented by formula I: 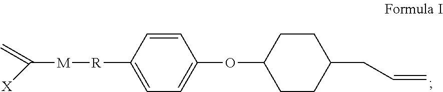
wherein M comprises a six-membered ring, and R comprises at least one of a single bond, a substituted or an unsubstituted alkyl group, and a substituted or an unsubstituted alkoxy group, and X comprises one of a hydrogen atom, and a substituted or an unsubstituted alkyl group.

2. The alignment film composition according to claim 1, wherein the additive comprises at least one of the following compounds of Formula II and Formula III: 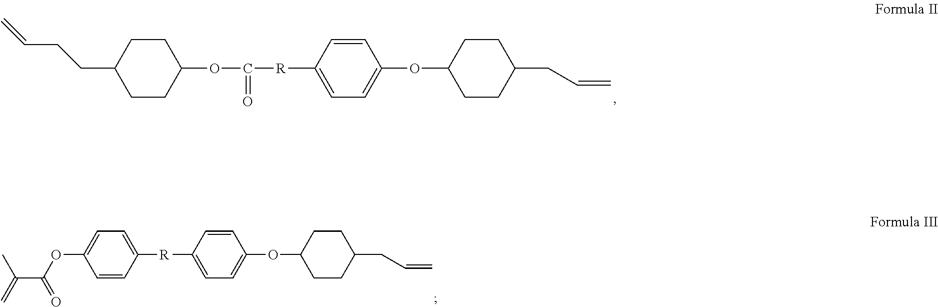
wherein the R comprises at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms;
the M in the formula I is 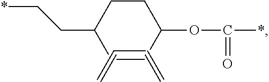
and the X is a hydrogen atom; or
the M in the formula 1 is 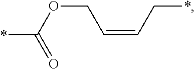
and the X is methyl.

3. The alignment film composition according to claim 1, wherein a mass content of the additive in the alignment film composition is greater than or equal to 0.5% and less than or equal to 10%.

4. The alignment film composition according to claim 1, further comprising a solvent, wherein the solvent comprises at least one of N-methyl-2-pyrrolidone, N-ethyl-2-pyrrolidone, butyl cellosolve, diethylene glycol diethyl ether, and diacetone alcohol.

5. The alignment film composition according to claim 4, wherein a molar ratio of the polyimide to the solvent is 30:70.

6. The alignment film composition according to claim 1, wherein the polyimide is obtained by reacting a dianhydride compound and a diamine compound.

7. The alignment film composition according to claim 6, wherein the dianhydride compound comprises at least one of cyclobutane-1,2,3,4-tetracarboxylic dianhydride, and other aromatic dianhydride compounds.

8. The alignment film composition according to claim 6, wherein the diamine compound comprises at least one of diaminodiphenylmethane, 1,3-diamino-4-{4-[trans-4-(trans-4-n-pentylcyclohexyl)cyclohexyl]phenoxy}benzene, and other aromatic diamine compounds.

9. The alignment film composition according to claim 6, wherein a molar ratio of the dianhydride compound to the diamine compound is 1:1.

10. A display panel, comprising:
a first substrate;
a second substrate disposed opposite to the first substrate;
a first alignment film disposed on a side of the first substrate close to the second substrate; and
a second alignment film disposed on a side of the second substrate close to the first substrate;
wherein each of the first alignment film and the second alignment film comprises at least one of the following functional groups: 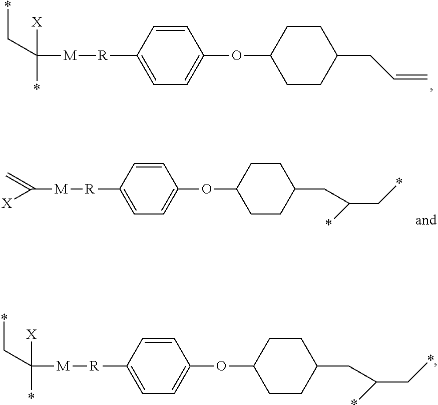
wherein M comprises a six-membered ring, and R comprises at least one of a single bond, a substituted or an unsubstituted alkyl group, and a substituted or an unsubstituted alkoxy group, and X comprises one of a hydrogen atom, and a substituted or an unsubstituted alkyl group.

11. The display panel according to claim 10, wherein both the first alignment film and the second alignment film are formed by a polyimide alignment agent, and the polyimide alignment agent is obtained from an alignment film composition,
wherein the alignment film composition comprises a polyimide and an additive, and the additive comprises a compound represented by formula I: 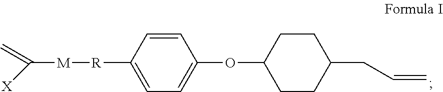
wherein M comprises a six-membered ring, and R comprises at least one of a single bond, a substituted or an unsubstituted alkyl group, and a substituted or an unsubstituted alkoxy group, and X comprises one of a hydrogen atom, and a substituted or an unsubstituted alkyl group.

12. The display panel according to claim 10, wherein the M comprises at least one of a phenyl group and a cyclohexyl group.

13. The display panel according to claim 10, wherein the R comprises at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms; and
wherein the M comprises one of

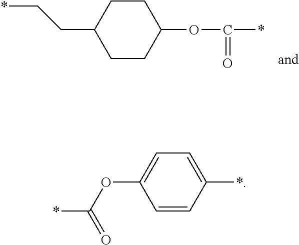

14. The display panel according to claim 13, wherein each of the first alignment film and the second alignment film comprises at least one of the following functional groups:

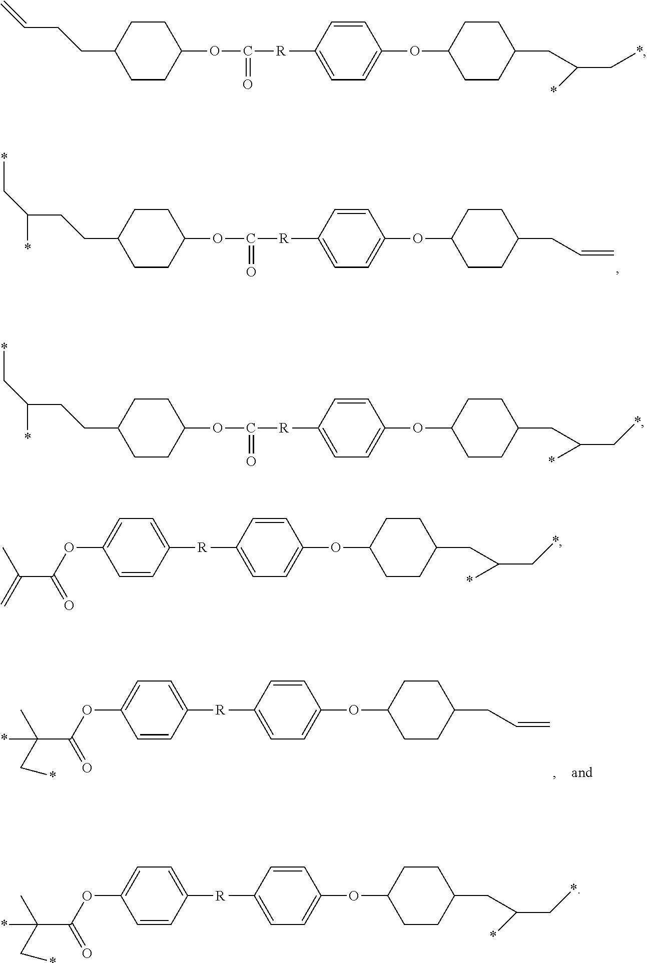

15. The display panel according to claim 14, wherein each of the first alignment film and the second alignment film comprises at least one of the following functional groups:

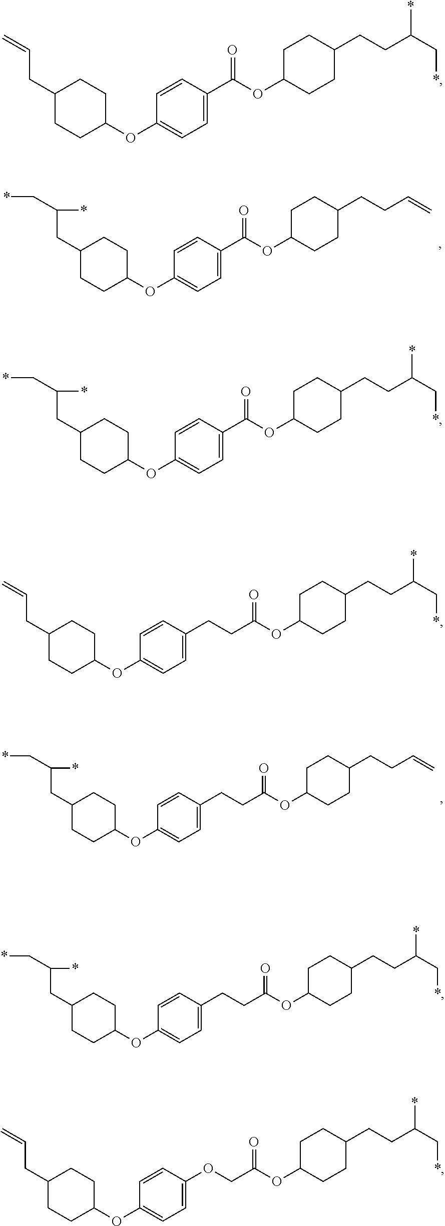

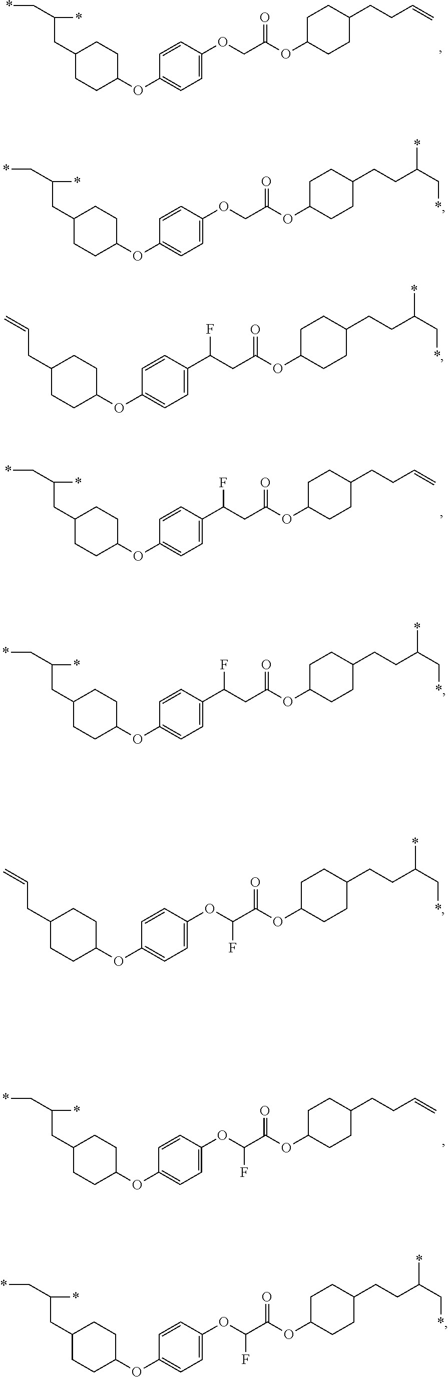

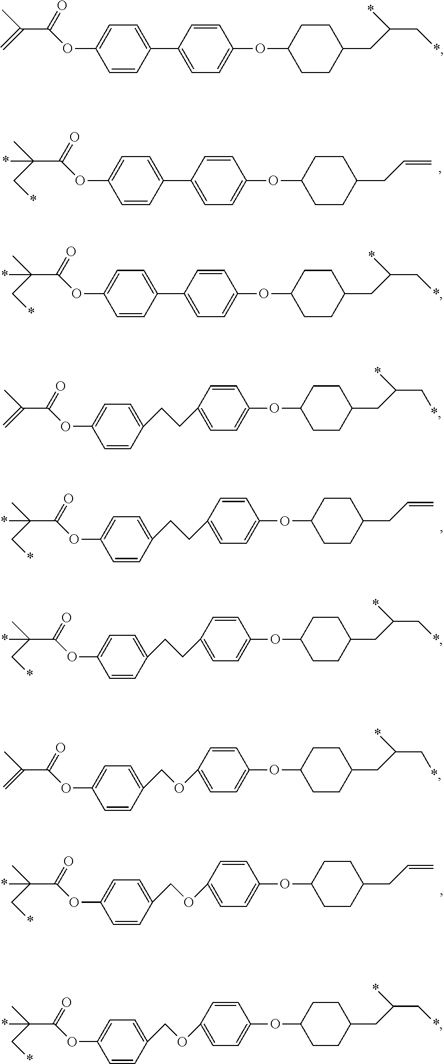

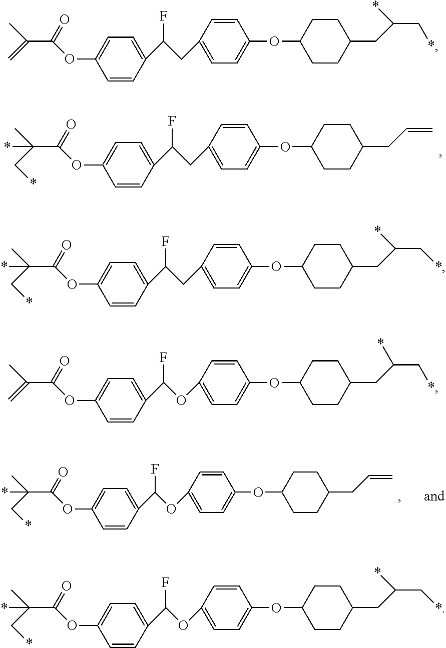

16. The display panel according to claim 10, further comprising a liquid crystal layer disposed between the first alignment film and the second alignment film, wherein the liquid crystal layer comprises liquid crystal molecules, and the liquid crystal molecules comprise at least one six-membered ring.

17. The display panel according to claim 16, wherein the liquid crystal layer further comprises a polymer network structure connected to the first alignment film and/or the second alignment film.

18. The display panel according to claim 12, wherein the R comprises at least one of a single bond, an alkyl group having 1 to 10 carbon atoms, an alkoxy group having 1 to 10 carbon atoms, a haloalkyl group having 1 to 10 carbon atoms, and a haloalkoxy group having 1 to 10 carbon atoms; and
wherein the M comprises one of

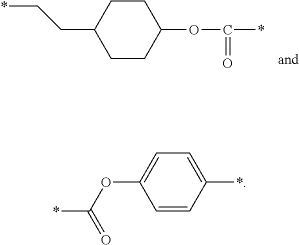

19. A method for manufacturing a display panel, comprising:
providing a first substrate and a second substrate;
providing a polyimide alignment agent obtained from the alignment film composition according to claim 1; and
forming a first alignment film and a second alignment film on the first substrate and the second substrate respectively by using the polyimide alignment agent.

20. A method for manufacturing a display panel, comprising:
providing a first substrate and a second substrate;
providing a polyimide alignment agent obtained from the alignment film composition according to claim 2; and
forming a first alignment film and a second alignment film on the first substrate and the second substrate respectively by using the polyimide alignment agent.
